(19) United States
(12) Patent Application Publication
(10) Pub. No.: US 2003/0061114 A1
(43) Pub. Date: Mar. 27, 2003

(54) System for and method of generating interactive on-line neighborhoods

(76) Inventors: Jeffrey S. Schwartz, San Diego, CA (US); Paul Shtein, San Diego, CA (US); Wilson P. Hatfield, San Diego, CA (US); Marvin A. Estrin, San Diego, CA (US)

Correspondence Address: PATENT METRIX, LLC, 14252 CULVER DR. #914, IRVINE, CA, 92604, US

(21) Appl. No.: 10/201,595

(22) Filed: Jul. 23, 2002

Related U.S. Application Data
(63) Continuation-in-part of application No. 09/592,240, filed on Jun. 13, 2000.

(51) Int. Cl. G06F 17/60; G06F 15/16; G06F 17/00

(52) U.S. Cl. 705/26; 709/218; 709/203; 705/14; 707/104.1

(57) ABSTRACT

The present invention is directed towards systems and methods that provide a highly interactive and informative online neighborhood directory for users, enables local businesses to establish a network presence in an affordable and rapid manner, and helps local businesses integrate their applications with a global network. In one embodiment, tools provided by an on-line provider enables local businesses to incrementally integrate their proprietary applications with third party systems over the Internet and list the integration protocol in a directory format, thereby allowing any company to integrate with one or more of their applications.

### CROSS-REFERENCE TO RELATED APPLICATIONS

This application is a continuation-in-part of co-pending application Ser. No. 09/592,240, filed Jun. 13, 2000, entitled “System for and method of generating interactive on-line neighborhoods”.

### FIELD OF THE INVENTION

The present invention relates generally to the field of network-based services and more specifically relates to systems and methods for generating, integrating, and providing access to collections of information: entities, activities, and events, including companies (as well as their products and services), people, partnerships, and other organizations, preferably organized in the form of virtual neighborhoods.

### BACKGROUND OF THE INVENTION

The transfer of information over computer networks has become an increasingly important means by which institutions, corporations, and individuals do business. Computer networks have grown over the years from independent and isolated entities established to serve the needs of a single group into vast interconnected networks that unite disparate physical networks and allow them to function as coordinated systems. Currently, the largest computer network in existence is the Internet.

The Internet is a worldwide interconnection of computer networks that communicate using common protocols. Millions of computers, from handheld wireless devices to low-end personal computers to high-end super computers, are connected to the Internet. Servers are used to share and distribute information among computer systems or similar devices. A computer system or similar device that communicates with a server is usually referred to as a client of the server and the server is often part of a host system. A client and a host exchange messages via a communication network using predetermined protocols. Such protocols are effectuated through a client/host model in which a requesting client transfers a request message to a host and the host in turn takes an appropriate action depending on the content of the request. Typically, the appropriate action for the request includes the transfer of a response message to the requesting client. To efficiently communicate between numerous points of contact, networks are designed such that they do not generally consist of dedicated paths from every point in the network to every other point in the network. Rather, servers are connected, in a web fashion, to other servers through routers that dynamically enable a communication pathway between a client device and server host. Referring to FIG. 1, a block diagram of the Internet 10 is shown. At this basic level, the Internet 10 is shown as having a plurality of clients 12 connected to a plurality of servers 14 by a network 16. The details of the network are well known to those of ordinary skill in the art.

The Internet has emerged as a worldwide community of electronically connected users who readily and regularly exchange significant amounts of information. The Internet continues to serve its original purposes of providing for access to and exchange of information among government agencies, laboratories, and universities for research and education. In addition, the Internet has evolved to serve a variety of interests and forums that extend beyond its original goals. In particular, the Internet is rapidly transforming into a global electronic marketplace of goods and services as well as of ideas and information.

This transformation of the Internet into a global marketplace was driven in large part by the introduction of an information system known as the World Wide Web (“the web”). The web is a unique distributed database designed to give wide access to a large universe of documents. The database records of the web are in the form of documents known as “pages”. These pages reside on web servers and are accessible via the Internet. The web is therefore a vast database of information dispersed across countless individual computer systems that is constantly changing and has no recognizable organization or morphology. Computers connected to the Internet may access the web pages via a program known as a browser. One powerful technique supported by the web browser is known as hyperlinking, which permits web page authors to create links to other web pages that users can then retrieve by using simple point-and-click commands on the web browser.

The pages may be constructed in any one of a variety of formatting conventions, including by example Hyper Text Markup Language (HTML), and may include multimedia information content such as graphics, audio, and moving pictures. Any person with a computer and a connection to the Internet may access any publicly accessible page posted on the web. Thus, a presence on the World Wide Web has the capability to introduce a worldwide base of consumers to businesses, individuals, and institutions seeking to advertise their products and services to potential customers. Furthermore, the ever increasing sophistication in the design of web pages, made possible by the exponential increase in data transmission rates and computer processing speeds, makes the web an increasingly attractive medium for advertising and other business purposes, as well as for the free flow of information.

The availability of powerful new tools that facilitate the development and distribution of Internet content has led to a proliferation of information, products, and services offered on the Internet and dramatic growth in the number of consumers using the Internet. In addition, commerce conducted over the Internet has grown and is expected to grow dramatically.

The Internet has emerged as an attractive new medium for advertisers of information, products and services to reach consumers and a powerful new infrastructure for conducting commerce. Mechanisms, such as directories and search engines, have been developed to index and search the information available on the web and thereby help Internet users locate information of interest. These search services enable consumers to search the Internet for a listing of web sites based on a specific topic, product, or service of interest. The ability to automatically send and retrieve data across the world allows companies to share information, coordinate inventories, and cooperatively work in new and highly productive ways.

Despite these benefits, advertising and conducting commerce over the Internet currently has several drawbacks for small to medium sized businesses.

First, in order for a person or a business to establish a presence on the Internet, they have to design, host, and maintain a web site. However, not everyone who wants to establish a presence on the Internet has the financial or technical ability to do so. This is especially true of individuals and small businesses. As a result, these small businesses may not be properly represented on the Internet or listed on Internet search engines. This poses a problem for both the business owner and the customer. The businesses tend to lose out on the clientele that they could possibly have generated through the Internet. The customer, on the other hand, would not be able to locate a neighboring shop/store/service provider for the desired product/service.

This is particularly true of customers searching for businesses that are geographically proximate, or local, to the customer. The local customer is indeed the main consumer of the goods/services offered by the small business owner. Local consumers generally tend to identify a particular business by a certain set of parameters, physical proximity being the most common of them all. The closer the business is to the consumer, the more likely that the consumer will frequent that business, assuming other things being equal. Studies have shown that consumers conduct a predominant amount of their business within less than five miles of their work or home. Thus, it would be in the interest of both the business owner and the customer, to have some kind of on-line neighborhood directory, listing and linking to the local businesses.

A number of products and services have been offered in an attempt to address this problem, but no currently known “local directory” 1) has the ability to constantly drive traffic to it, 2) is able to focus on the small to medium sized business, 3) is national in reach, and 4) is affordable to the small to medium sized business.

The companies providing such a service are either too expensive, do not provide any service or content for their fee, or fall into one of the major flaws referenced above. Their typical approach includes having a universal portal, or entry point, to the communities accessible over the Internet that then links to various sub-communities that are presented by local website operators. Examples include AnytimeNews.com, Our-Hometown.com, Koz.com, as well as Citysearch.com and Digital City. Their typical approach requires a local web site operator, also referred to as a local e-commerce site provider, to identify and locate small businesses existing in the community/neighborhood, which is a very labor-intensive process. Conversely, simply waiting for local businesses to find the local site operator is not effective because coverage may be incomplete, causing users to not rely on the service to find businesses.

Second, while some current “directories” may provide services to help local businesses get on the Internet, they do not help integrate that local business into the larger world of e-commerce. Local businesses often have proprietary software systems that are not connected to the Internet, including accounting, inventory, human resource, and other software applications. Although such businesses would realize productivity enhancements by integrating those applications with network-based resources, few businesses have the technical sophistication or resources to take isolated systems and interconnect them with other systems available over a network. Although such directories would be the best place to find, list, and integrate with other businesses, such as suppliers and buyers, current directories do not assist businesses in becoming on-line ready, nor do they describe how a user or other business could integrate with the listed businesses.

Third, existing on-line directories are unable to provide local businesses with additional marketing opportunities, such as through co-operative marketing arrangements with larger businesses. Major consumer product companies would like to more aggressively reach out to the small business selling those products within communities. However, their ability to do so is hampered by the lack of knowledge large companies have of local small businesses and the lack of familiarity small businesses have with the marketing programs of larger companies.

A definite need exists for a system having an ability to be a complete online resource for small to medium businesses, as well as a localized source for community-specific information, that 1) has the ability to drive traffic to it, 2) focuses on the small to medium sized business, 3) is national in reach, and 4) is affordable. Additionally, a need exists for a network-based service that helps small to medium size businesses incrementally integrate existing proprietary applications with a global e-commerce network. Ideally, such systems and methods cost less and have a higher productivity rate than current systems.

### SUMMARY OF THE INVENTION

The present invention is directed towards systems and methods that provide a highly interactive and informative online neighborhood directory for users, enables local businesses to establish a network presence in an affordable and rapid manner, and helps local businesses integrate their applications with a global network.

In one embodiment, the on-line directory system comprises of an interactive on-line neighborhood provider, a neighborhood link provider, and a neighborhood content provider. The on-line provider reserves domain names, and designs, hosts and maintains websites for the neighborhood, providing the core technical support that facilitates the creation, maintenance, and ongoing functioning of the neighborhood. The link provider is a local entity that is the primary conduit through which local businesses will be brought in for the purposes of participating in the neighborhood. The content provider is the individual or small to medium business owner who is a member of the neighborhood. Content providers supply information about the neighborhood and utilize the systems and methods discussed herein to integrate into a global commerce community.

In a second embodiment, the online provider makes available to the link provider and content provider a set of tools to help them create their own Internet presence and assist in translating their content onto the Internet. For example, the on-line provider would distribute a software application to the link provider, either through physical distribution or download over the Internet, that assists the link provider in translating its existing portfolio of text, graphical, audio, and video advertising into content that is transmissible over the Internet. In another embodiment, the on-line provider delivers a software application to the local businesses, the content providers, which assist them in preparing and cataloging content.

In a third embodiment, the tools provided by the on-line provider enables the local businesses to incrementally integrate their proprietary applications with third party systems over the Internet and list the integration protocol in a directory format, thereby allowing any company to integrate with one or more of their applications. For example, having been informed that its supplier can now receive purchase orders electronically, content provider wishes to automatically communicate the status of its inventory to its supplier, thereby saving time and labor in manually creating and sending a set of purchase orders. Content provider obtains, either by downloading it via the Internet or by ordering it via phone, a copy of the integration interface for its inventory application. The integration interface is installed such that it is in communication with the middleware layer of the aforementioned tools. In use, the content provider can launch the application and perform a plurality of management functions similar to those conducted for the provisioning of content to the on-line provider. More specifically, content provider can import data into the application from the inventory application, transform that data by stripping out information, reformatting it, or generating specific purchase orders, and transmit that data to the appropriate receiving source.

In a set of additional embodiments, the present invention also helps drive traffic to the link providers and content providers by 1) allowing users of handheld, wireless devices to quickly obtain a listing of businesses proximate to its geographic position, 2) providing additional functionality in the form of on-line reservations, 3) issuing on-line coupons and 4) providing additional value added information, through licensed content, emergency information, traffic reports, or event information.

The present invention also enables new cooperative marketing techniques to be effectuated. By enabling the aforementioned content delivery and commerce activities, the present invention builds a rich database of products and services associated with numerous local businesses. Such a database can be used by the on-line provider and/or link provider, acting on behalf of its local business customers, to unite the marketing objectives of larger, nationwide companies, or other supplier companies, with local businesses.

The scope and substance of each of the aforementioned embodiments, along with other inventive methods and systems, shall now be described.

### BRIEF DESCRIPTION OF THE DRAWINGS

The above and other objects and advantages of the present invention will be readily appreciated from the following detailed description when read in conjunction accompanying drawing, wherein:

FIG. 1 is a block diagram of the Internet;

FIG. 2 is a block diagram of a system for generating interactive on-line neighborhoods according to one embodiment of the present invention;

FIG. 3 is a block diagram of one embodiment of a software application used by local businesses to manage content;

FIG. 4 is a block diagram of the incorporation of an integration interface into an existing Internet management application;

FIG. 5 is a process flow diagram of one embodiment of the on-line provider facilitation of e-commerce data between supplier and the content provider;

FIG. 6 is a process flow diagram of one embodiment of the on-line provider facilitation of e-commerce data between a requesting company and the content provider;

FIG. 6a is a process flow diagram of the login and password issuance process to the requesting company;

FIG. 7 is a process flow diagram of a user searching the on-line neighborhood;

FIG. 8 is a process flow diagram of how an on-line neighborhood is generated in one embodiment;

FIG. 9 is a process flow diagram of a wireless-based use of the present invention;

FIG. 10 is a process flow diagram of a method for using the present invention to conduct co-operative marketing;

FIG. 11 is a process flow diagram of one method for link providers to manage site functionality;

FIG. 12 is a process flow diagram of one method for link providers to edit a specific site function; and

FIG. 13 is a process flow diagram of one method for a user to customize a personal web page.

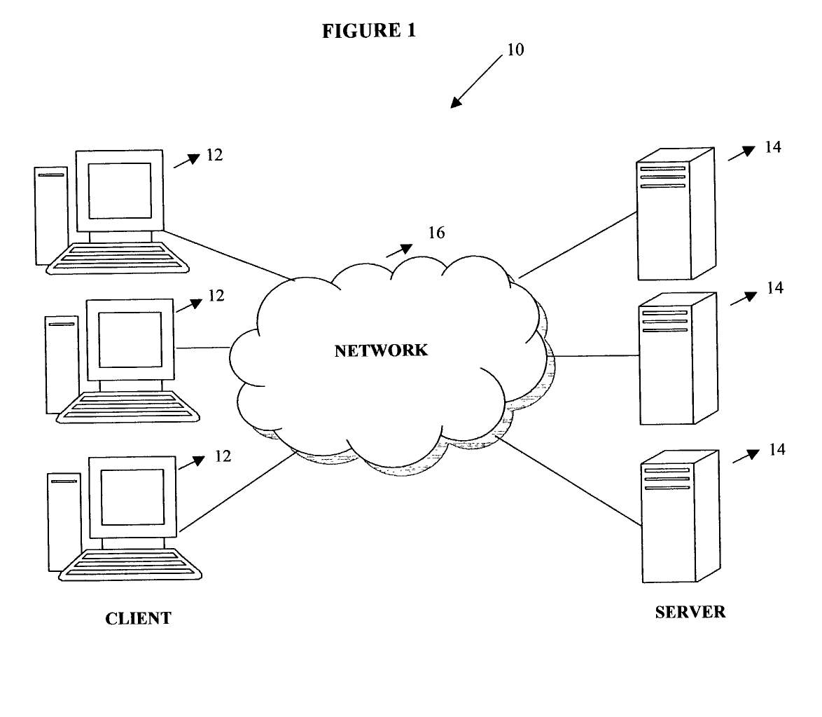

### DETAILED DESCRIPTION

The present invention is directed towards systems and methods that provide a highly interactive and informative online neighborhood directory for users, enables local businesses to establish a network presence in an affordable and rapid manner, and helps local businesses integrate their applications with a global network. Reference will now be made in detail to specific embodiments of the invention. While the invention will be described in conjunction with specific embodiments, it is not intended to limit the invention to one embodiment.

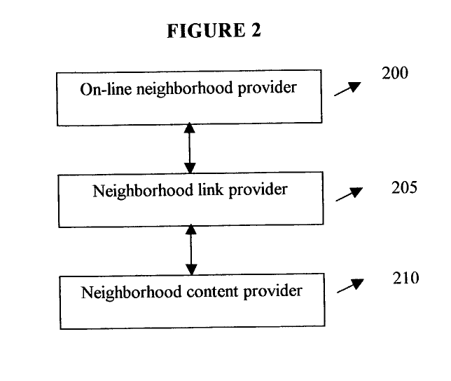

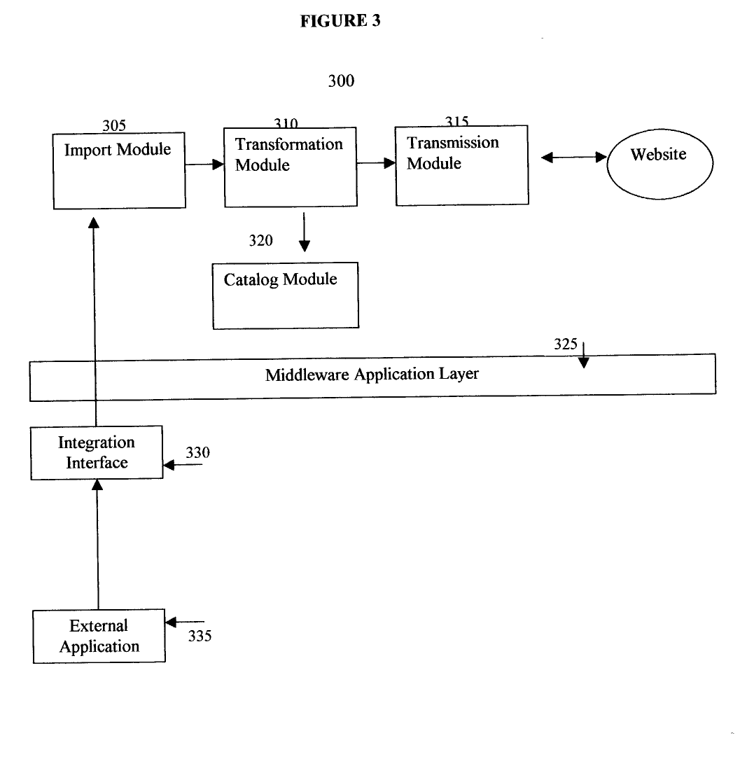

Referring to FIG. 2, in one embodiment, the on-line directory system comprises of the following entities: an interactive on-line neighborhood provider (200), a neighborhood link provider (205), and a neighborhood content provider (210). The on-line provider 200 reserves domain names, and designs, hosts and maintains websites for the neighborhood. Alternatively, the on-line provider 200 may not host and maintain a website, but, rather, preserve linkages to such sites. Although inherent in the name, a neighborhood can be any type of virtual community, including a geographically defined virtual community (all users belonging to a specific area), a neighborhood defined by a user's tastes, industry-based neighborhoods, profession-based neighborhoods, and corporation-based neighborhoods. As discussed below, the on-line provider provides the core technical support that facilitates the creation, maintenance, and ongoing functioning of the neighborhood. The link provider 205 is a local entity that is the primary conduit through which local businesses will be brought in for the purposes of participating in the neighborhood, such as a local media outlet. Preferably, the link provider 205 is able to establish and maintain strong contacts with local businesses within a geographically defined area. Examples of link providers 205 include local television, radio, and print media, such as a small local magazine or newspaper, chambers of commerce, local clubs, organizations or associations. The content provider 210 is the small to medium business owner or organization who is a member of the neighborhood. Content providers supply information about the neighborhood and utilize the systems and methods discussed herein to integrate into a global commerce community. Alternatively, a content provider 210 may be any third party who can provide relevant content about a neighborhood.

The on-line provider preferably delivers all the technical support and services required to enable a business to establish an on-line presence. Assuming the local business has already established a network connection through a telecommunications provider, such as a satellite provider, cable company, AT&T, Qwest Communications, or Worldcom, the local business may access the web site of the on-line provider and use various tools and services provided by the on-line provider to make its content network accessible. Users may use the features of the on-line provider, accessed via the link provider, to search for and identify desired neighborhoods, goods, services, and other information.

One service that the on-line provider preferably delivers to local businesses is web hosting. In order for a person or a business to establish a presence on the Internet, they have to reserve a domain name and design, host, and maintain a web site. However, not everyone who wants to establish a presence on the Internet has the financial or technical ability to do so. This is especially true of individuals and small to medium businesses. Web-host services may be offered to address this problem.

Using a set of tools, business information is gathered from the content providers i.e. the business owners or organizations. This information preferably includes the name, address, telephone number and the type of business dealt in. The business owner can also list other information, if it desires. The web design tools include, but are not limited to: Java, HTML, XML, Flash animation, custom graphic design, logo development, database development, and e-commerce packages.

Servers, maintained by the on-line provider, can be accessed by the local business by example, in order to post and/or manage advertising, weekly/daily specials, an events calendar that can be maintained on a business-specific, neighborhood-specific or even personal—specific events calendar, a guestbook for receiving comments from users, mailing list to send users information on particular topics, a message board to allow users to discuss various topics with each other, web site links, online reservations, a search engine, employment opportunities, current product inventory, and coupons and promotional offers.

Typically, the process of delivering content to the servers for inclusion in the on-line neighborhood includes 1) designing the content and 2) uploading the content onto the servers associated with the local business' web presence, i.e. its Internet Protocol address. The on-line provider preferably shall provide businesses with a network accessible, easy to use interface allowing them to update or change content of their sites on their own. This is accomplished by providing a secure web site that each business can access with a dedicated login username and password. Once accessed, the business can upload and manage the aforementioned content.

The online provider's tools are also available to the link provider to help the link provider create its own Internet presence and to assist in translating the link provider's advertising content onto the Internet. As further discussed below, the link provider may have a large amount of content in print, audio, or video form that could be distributed across the Internet, provided such content was properly formatted for network transmission.

In a first embodiment, the on-line provider would distribute a software application to the link provider, either through physical distribution or download over the Internet, that assists the link provider in translating its existing portfolio of text, graphical, audio, and video advertising into content that is transmissible over the Internet. The application would preferably have features that enable quick and easy editorial and advertising changes, archival capabilities, templates for various kinds of newspaper pages, such as articles, various sized ads, classifieds, TV listings, and legal notices, local events and calendaring, and a set of conversion tools for translating text, graphic, audio, and video content into network transmissible content.

For standard text or graphics, already electronically stored content could be exported in various file formats substantially universally supported by browsers, such as JPEG or GIF for graphic formats and Word, Quark, or any other text formats. Where the content is paper based, it can be scanned into a computer, using any scanning device and software application used to manage a scanning device and then saved in the appropriate formats. One of ordinary skill in the art would appreciate many different formats exist and are included within the scope of this invention. For audio and/or video, the conversion tools may comprise a plurality of encoders that conform to current encoding standards being promoted by Microsoft, Apple, and/or RealNetworks. In operation, the encoders digitize, compress and format the video or audio content, thereby packaging that content for easy transmission, storage, and future playback by client devices having the appropriate client player software. The compression, encoding, and formatting processes are known and can be practiced by one of ordinary skill in the art.

In another embodiment, the on-line provider delivers a software application to the local businesses, or the other content providers, which assist them in preparing and cataloging content. The application may be delivered through the physical distribution of a CD ROM or through a download from a web site. Alternatively, it may reside on a set of servers, possibly the on-line provider's servers, and be accessed over a network. Because the application has numerous uses, all geared toward managing a content provider's work with the Internet, it will be referred to as the Internet management application.

Referring now to FIG. 3, a block diagram of the Internet management software application 300 is shown. The application 300 comprises a plurality of modules, including an import module 305, transformation module 310, transmission module 315, catalog module 320, and a middleware application layer 325 that permits for the incorporation of integration interfaces 330 that interact with one or more external applications 335.

The import module 305 is used by the content provider to import content generated through its existing systems and applications and outputted in various text, graphical, audio, video, and other formats. Using the import module 305, the user designates the source of content and the format of the content. The content is accessed from an external application 325 or file storage source (not shown) through the middleware application layer 325 and interface 330 and opened as a file in the application 300. The transformation module 310 can then be used to change the existing format to a new format that is capable of being effectively transmitted and displayed and/or played across the Internet. As previously mentioned, that process could include the transformation of content into JPEG or GIF images, the encoding, compressing, and formatting of content using specialized protocols, or the translation of standard text into HTML-compatible data.

The transmission module 315 takes the transformed and stored content and enables it to be uploaded into the proper on-line provider server where it is stored in a central database that may be later accessed by users performing searches or requesting information. The catalog module 320 allows the content provider to intelligently manage the content created by enabling the content provider to categorize content, file it in relation to various criteria, and search for content using that criterion.

The middleware layer 325 has been designed to allow the application 300 to gain functionality as the content provider becomes more comfortable with the Internet. More specifically, the content provider has a plurality of proprietary applications it currently uses, across one or more client devices, to conduct standard business functions such as accounting, human resource management, inventory management, among many others. As the business grows, it may want to integrate those isolated functions with network-based services, such as those provided by financial institutions, suppliers, and/or buyers. The application 300 provides them a rapid way of doing so.

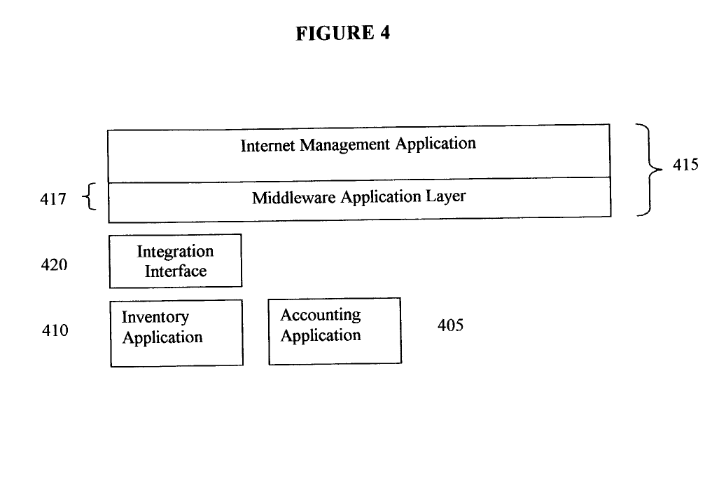

Referring to FIG. 4, a content provider has an accounting application 405, an inventory application 410, and the Internet management application 415 with middleware layer 417. Having been informed that its supplier can now receive purchase orders electronically, content provider wishes to automatically communicate the status of its inventory to its supplier, thereby saving time and labor in manually creating and sending a set of purchase orders. Content provider obtains, either through the Internet or by phone, a copy of the integration interface 420 for the inventory application 410. The integration interface 420 is installed such that it is in communication with the middleware layer 417 and a part of the Internet management application 415. If already hosted on a server, it is activated as part of the content provider's account.

In use, the content provider can launch the Internet management application 415 and perform a plurality of management functions similar to those conducted for the provisioning of content to the on-line provider. More specifically, content provider can import data into the Internet management application 415 from the inventory application, transform that data by stripping out information, reformatting it, or generating specific purchase orders, and transmit that data to the appropriate receiving source.

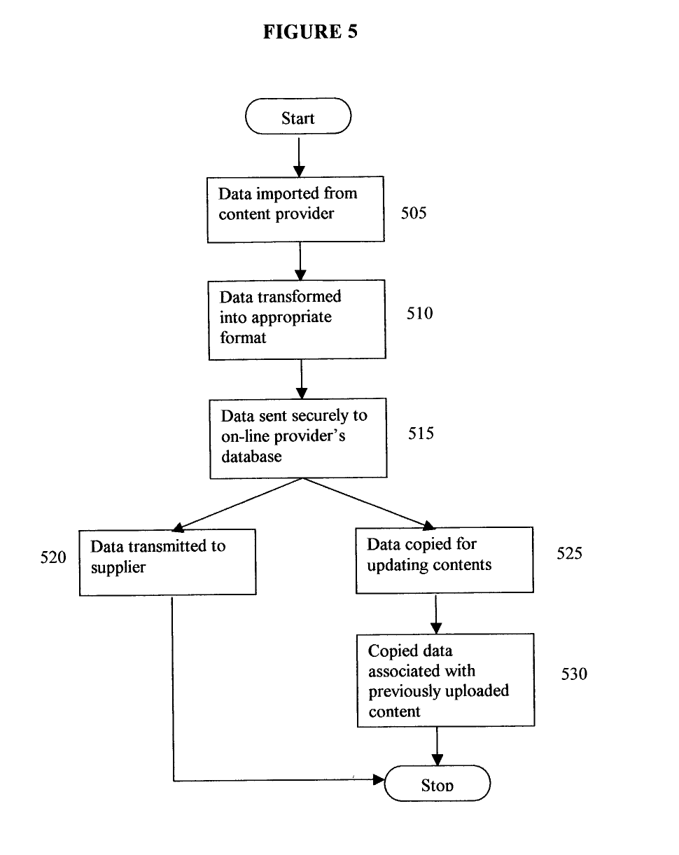

In one embodiment, the on-line provider facilitates the secure communication of this e-commerce data between supplier and the content provider. Referring to FIG. 5, a process flow diagram is shown. In the most basic process, data is imported 505, transformed 510, and securely sent 515 to the on-line provider's database. The on-line provider then transmits 520 that data, or portions thereof, to the supplier while keeping 525 a copy of the business' inventory levels and associating 530 that data with the content data that the content provider previously uploaded.

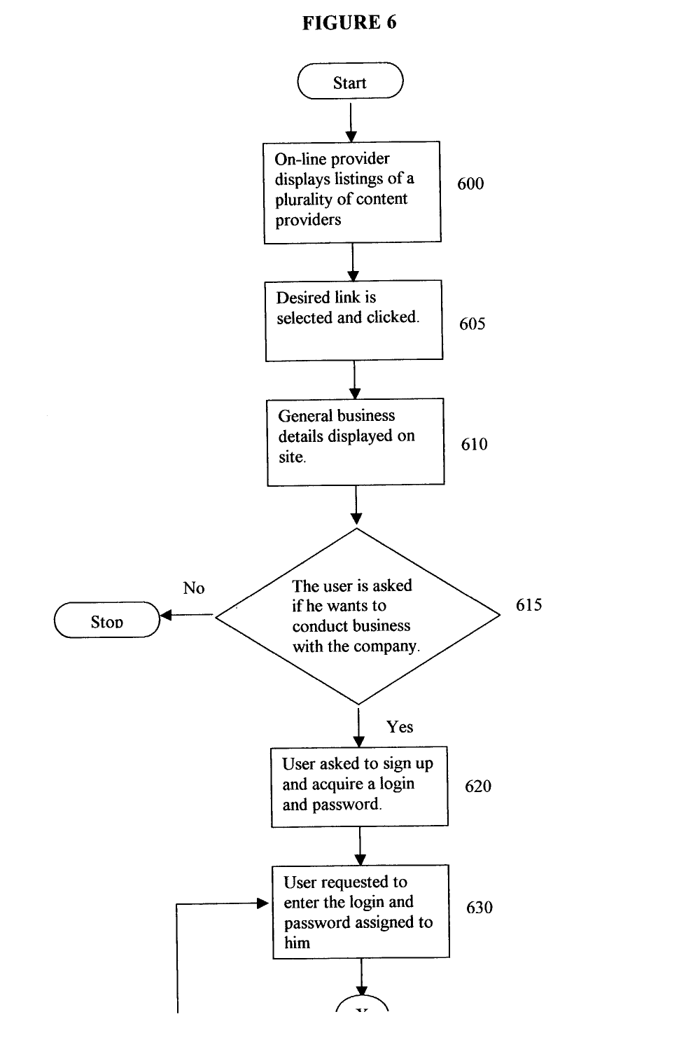

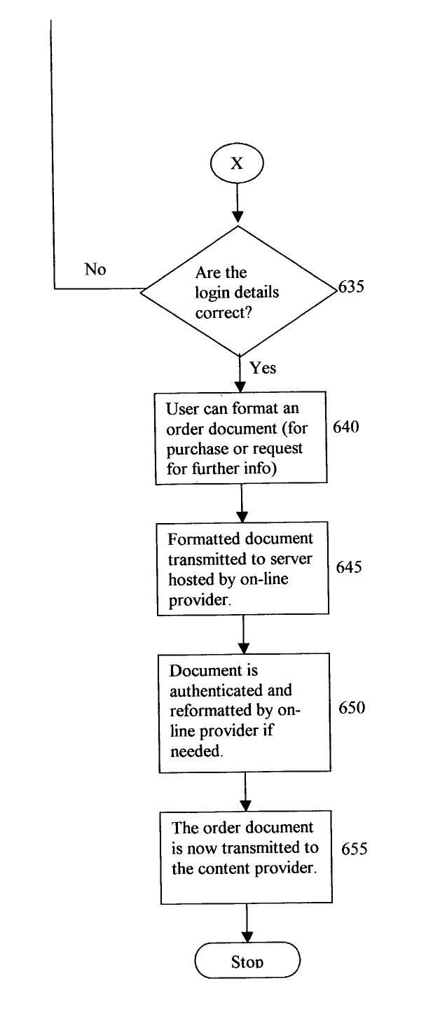

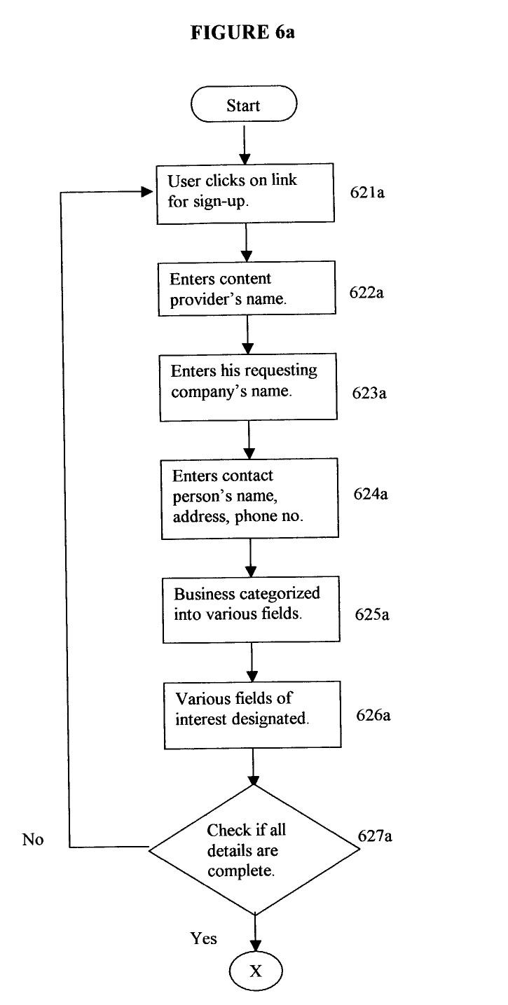

In a preferred embodiment, the on-line provider actively manages the secure communication of this e-commerce data between supplier and the content provider. Referring to FIG. 6, a process flow diagram is shown. The on-line provider displays 600 the listings of a plurality of content providers. The customer selects the business that he desires, and clicks 605 on the selected link. The click generates 610 the web page of that particular business. In addition to basic demographic information, the page displayed includes a set of protocols for any company that would like to electronically conduct business with the listed company. Such a display could include 1) process for obtaining a login and password, 2) types of data accepted by the displayed company, 3) formats for sending that data, and 4) where to send that data. The user is now asked 615 whether he wants to conduct on-line business with the selected content provider.

Referring to FIG. 6a now, the login and password issuance process (i.e. module 620 of FIG. 6) has been shown in detail in the form of a flow diagram. A company wishing to conduct business with the content provider accesses 621a login and password issuance process hosted by the on-line provider, and clicks on the “sign-up” link. The process could require entry 622a of content provider's name, entry 623a of the requesting company's name, input 624a of a contact person's name, address, and phone number, categorization 625a of the business into various fields, and designation 626a of various fields of interest. Once complete 627a, the information is submitted 628a to the server. The data is now stored 629a in a customer database. Finally, the requesting company is issued 630a a password and login. One of ordinary skill in the art would appreciate that other information could be requested and could be requested in differing order.

Referring back to FIG. 6, the user is requested to enter 630 the login and password assigned to him. The login details are matched from those stored in the database and are checked 635 for validity. Using the password and login, the requesting company formats 640 an order document, preferably directed toward the purchase or request for information relating to the displayed company's products and/or services. The formatted document is then transmitted 645 to a server hosted by on-line provider that performs 650 the necessary authentication and reformatting, if necessary, prior to transmission 655 to the local business. The on-line provider then transmits 655 that data, or portions thereof, to the business.

Certain features are preferably only accessible through the neighborhood link provider, specifically those features that will be used by users to form and identify neighborhoods tailored to their needs. For example, a search module shall be provided by the link provider and supported by the on-line provider. The on-line provider supports a search engine to search and locate any desired business or service in a particular community. The search module comprises a database to store the details of various businesses and services listed with the on-line provider, a website which generates the search template through user interaction, and a database connectivity mechanism to generate dynamically the search results and provide the same to the user.

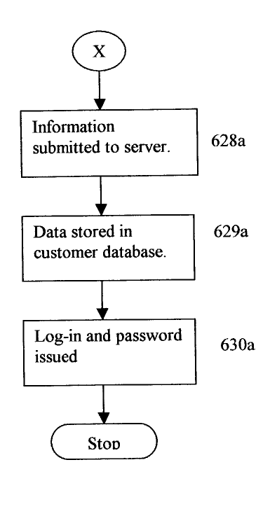

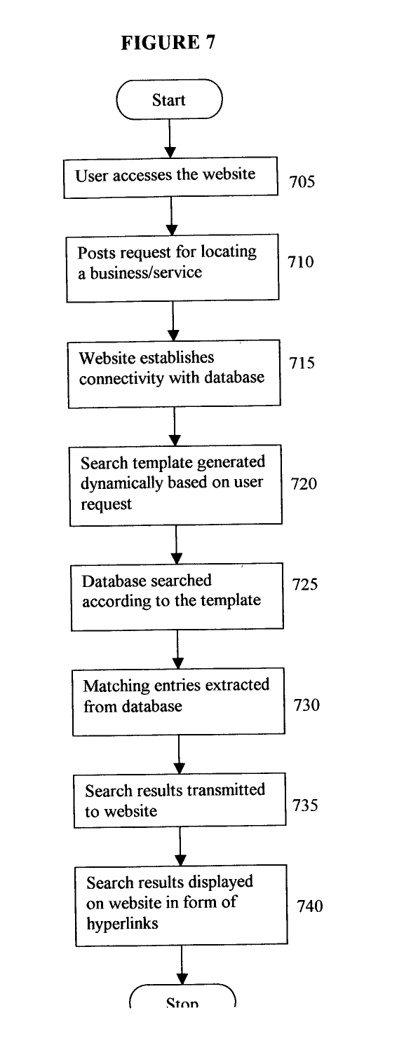

Referring to FIG. 7, a user accesses 705 the link provider's website, hosted by the on-line provider. On request 710 from the user for locating a particular business or service, the website connects 715 to a database containing content previously provided by a plurality of content providers. Based upon user's inputs, a search template is dynamically developed 720 that reflects the type of business/product/service the user is attempting to identify. The database is searched 725 for the desired search criterion as per the generated search template. The matching entries are extracted 730 from the database. The corresponding search results are conveyed 735 to the website. The search results are displayed 740 on the website in form of hyperlinks to the corresponding web pages for businesses as desired by the user.

In an attempt to offer a better interactive on-line neighborhood, the link provider and/or on-line provider may add content to the site that is beyond that from the content provider. An example of such content would be a community page where a consumer can search in their specific community. The community page may contain categories and subcategories of content including but not limited to places of interest, government services, and children's activities. In addition, the community page may contain an interactive calendar of events. Such additional content should act to draw consumers to the site. Furthermore, the interactive on-line provider establishes an affordable priority search system for the local goods and services provider, at the same time providing additional information about the provider and the goods and services provided to the consumer.

Link providers connect the on-line provider with the local businesses, i.e. content providers. One example of a link provider is the local television, radio, and print media such as a small local newspaper. Typically, such a newspaper has limited circulation and publication days. Generally, the newspaper does not have national recognition. However, the newspaper may have strong local recognition. For instance, the newspaper might be based on proximity, ethnicity, religion or affinity, among others. Such a newspaper might also be a school newspaper. Often, a small to medium business will spend a significant portion of its advertising budget with such a newspaper. As a result, the newspaper has knowledge of and contact with the neighborhood in which it is circulated. It is this group of advertisers that may be used to define a neighborhood for the on-line provider. Further, advertisers already accustomed to the link providers are primed to be content providers who will be the basis of the on-line neighborhood. The content may include a wide variety of items such as the name of the business, their contact information, their products and services, and their promotions and sales.

Another example of a link provider is a local club, organization, or association. Such a club might be based on work or leisure. For instance, the club might be based on ones jobs or education or it might be based on ones hobbies or causes. Such clubs provide the small to medium business owner a very specialized market for their advertising expenditure.

Content providers typically become part of the on-line neighborhood through working with the link provider. For instance, a local business, i.e. content provider, contacts a local newspaper, i.e. link provider. Because local businesses spend a significant portion of their advertising budget with local newspapers, the newspaper has knowledge of and contacts with the businesses in the neighborhood that it is circulated. These may be small to medium community businesses that have been advertising with the newspaper, but don't have the technical or financial ability to establish their presence on the Internet. These can also be other unknown businesses or services that would be interested in getting listed on the Internet.

The newspaper publisher can ask these small business owners to submit their details so that they may be added to the database. This may be done by means of research, surveys, inquiries, one-to-one correspondence with the business owners, or, by an on-line interactive interface. Once the business details of the small businesses are gathered, they are sent to the database. Basic business listings typically provide at least the company's name, address and telephone number. Each listing may be enhanced by incorporating the business' attributes they wish to promote. These attributes are gathered from one or more sources including personal interviews with the business, yellow page listings, advertising, collateral and other sources. The listing may include, as previously discussed, methods of integrating with the content provider's existing business applications.

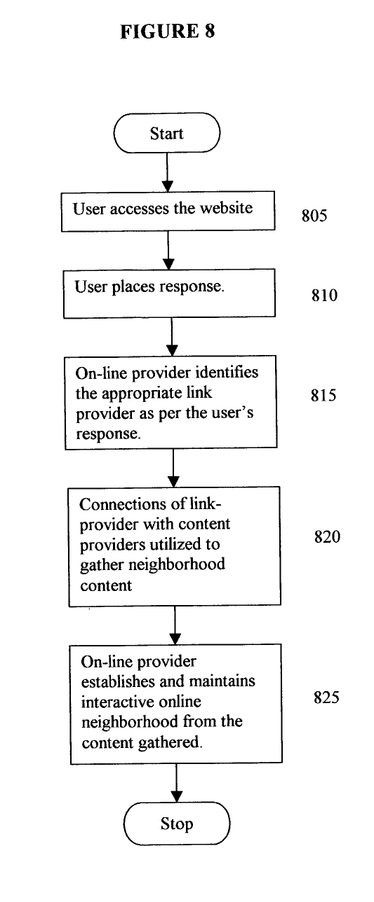

The present invention helps drive traffic to content providers through a variety of mechanisms. One embodiment is shown in FIG. 8. A user comes 805 to the on-line provider's site. In response to user's interaction 810, the on-line provider identifies 815 the appropriate link provider. The link provider may be one of an overlapping set of link providers or may be a stand-alone provider. The on-line provider utilizes 820 the connections of the link provider to the content provider to gather neighborhood content for the interactive on-line neighborhood. These connections may be based on a business relationship or on a non-profit relationship and will depend on the type of link provider. The on-line provider establishes and maintains 825 the interactive on-line neighborhood built on the content from the content provider. Through the method, the link provider receives an additional source of income and maximizes their on-line presence. In addition, the content provider promotes their content and, in a business context, expands their business. The resulting on-line neighborhood benefits the consumer by allowing them to research and interact with local content and to find and conduct local business. These benefits are especially valuable to the consumer that is new to or temporarily in the neighborhood.

In a second embodiment, the on-line provider transparently generates the appropriate neighborhood under the guise of the link provider. The interactive online neighborhood provider provides services to the link provider as if the neighborhood link provider were offering all those services themselves. Preferably, users will be unable to determine whether the services are provided by the neighborhood link provider or another party. For example, a user accesses the web site of a link provider, hosted by the on-line provider. The URL of the link provider is preferably unique to that local provider, i.e. the name of the newspaper or club. The user can then access the search modules accessible via the link provider's site to find the appropriate content providers and create a search template indicative of an on-line neighborhood.

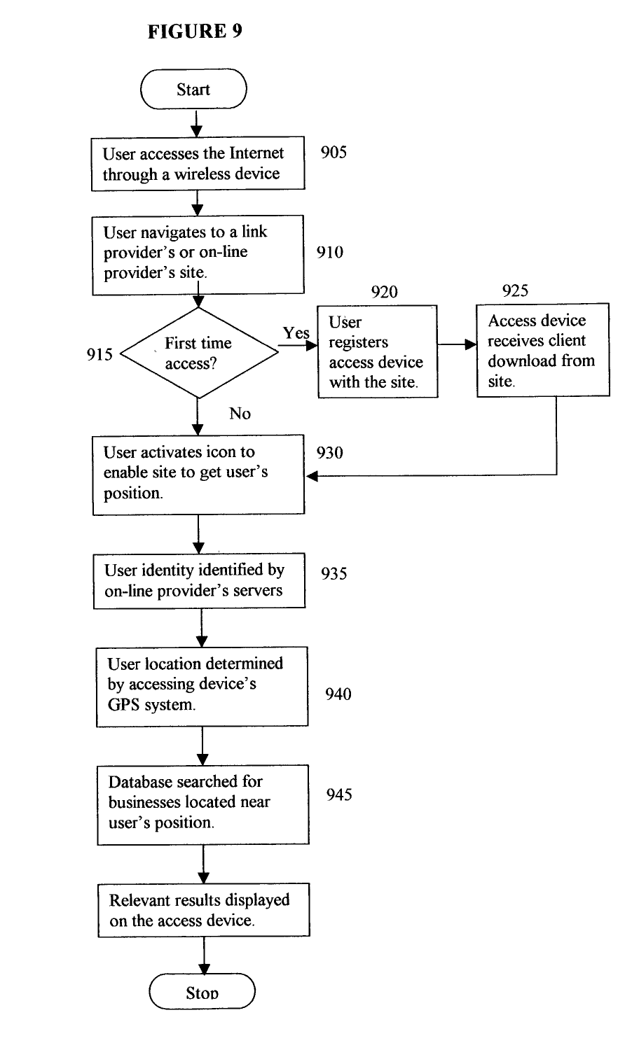

In a third embodiment, a user has a handheld, wireless device capable of accessing the Internet, such as a personal data assistant, Internet-enabled phone, or vehicle-integrated communication device, with global positioning capabilities. As one of ordinary skill in the art would appreciate, global positioning satellite (GPS) functionality is being incorporated into many different types of mobile devices, including personal data assistants, phones, and vehicles. Referring to FIG. 9, a user accesses 905 the Internet through the wireless device. The user navigates 910 to a link provider's site, hosted by the on-line provider, or the on-line provider's site. The on-line provider checks whether the user and his access device has been registered with the site or not. Preferably, the user has previously accessed the link provider or on-line provider's web site, registered 920 his or her access device with the site, and, in return, received 925 a client download that 1) helps identify the access device to the on-line provider's servers and 2) provides the on-line server access to the device's GPS system. The user activates 930 an icon, present on either site that instructs the site to get the user's position. The icon may be a graphical button overlaid with the phrase “Get Position”.

Once pressed 930, the on-line provider's servers accesses the client download to 1) verify 935 the identity of the user and 2) access the device's GPS system to determine 940 the user's location. With the user's location obtained 940, the on-line provider's servers searches 945 database for data relevant to content providers located within a specific geographic radius of the user's location. The relevant results are then displayed 950 on the user's access device's screen. That retrieved geographic-specific data could then be further tailored by the user to identify specific types of businesses the user could visit. More specifically, the link provider's or on-line provider's web site could provide a set of criteria that the user can select, i.e. through drop-down text boxes, to narrow the results, thereby allowing a user to specifically identify restaurants, then Asian restaurants, then Japanese restaurants, and finally those Japanese restaurants with on-line reservation systems. This centralized, hosted approach to enabling users to access specific businesses via a wireless device drives even more traffic to content providers without requiring any technical prowess on the part of the business itself.

Preferably, the link provider, through the on-line provider's system, or on-line provider directly allows a user to accumulate preference data that will enable tailored or personalized responses. For example, a user can access the link provider's, or on-line provider's, site, input favorite items, such as restaurant types, and have those items stored in a database. When the user activates the “Get Position” icon, the system can access that data, knowing the identity of the user, and use that data to guide the selection of specific geographic data identified in the GPS-based data collection process.

Other systems may be provided by the on-line provider either directly to the local businesses or through the link providers who work with them. A first system allows local businesses to create an on-line reservation system. As with other web hosting services, the on-line provider could provide content providers and/or link providers with a template online reservation interface that 1) could be tailored to the specific data requirements and look and feel of each business and 2) could be used by a consumer to book a reservation for the local business via an Internet accessible interface. A typical interface might include a set of drop down boxes that require the potential customer to identify the service desired, the number of people in the party, the dates and times for the reservation, and a billing method to guarantee the reservation. One of ordinary skill in the art would appreciate that numerous other types of data could be requested and obtained from a potential customer. In operation, the data is obtained from the customer and sent to a reservation system that maintains a current status account of what dates and times are available for reservation and at what price. If an appropriate date and time can be identified, the potential customer is notified that such reservations are possible and at what price and terms. If not, the potential customer is notified that reservations are not available and is requested to select a different date and/or time.

Such systems may be incorporated with additional dissemination information, including, but not limited to, menus, traffic conditions, and directions to the restaurant. For example, after conducting an on-line reservation, a user may further request menu information. In a preferred embodiment, the user is able to append menu information to his on-line reservation by indicating within a text box, associated with the above described interface, special requests, such as a particular bottle of wine, or orders, such as meals that require substantial preparation time.

Other systems that may be offered by the on-line provider to local businesses and/or link providers includes marketing/promotional services designed to help the local business further develop its ties with local consumers. For example, the present invention may be used to issue on-line coupons to consumers who, upon retrieving the name of the local business from the on-line provider's or link provider's site, may be automatically offered a coupon that could be downloaded into a personal data assistant or other wireless device or printed on a regular printer. In operation, a content provider could use the Internet management application to issue coupons, the number and value of which are integrated with their proprietary accounting application through an integration interface, and upload the issued coupons into an on-line provider database. The database correlates those coupons with specific criteria, as designated by the content provider, including the name of the business, type of service being requested, or the type of consumer requesting the data. Upon conducting a search and selecting a business, a consumer would then receive the appropriate coupons from that business. The coupons may then be downloaded into a wireless device or printed. At the local business, the consumer may either physically present the coupon or electronically transmit the coupon through a physical or wireless, i.e. infrared, connection.

In addition to having traffic driven to their sites and improved e-commerce capabilities, the present invention is directed toward novel systems and methods for cooperative marketing. By enabling the aforementioned content delivery and commerce activities, the present invention builds a rich database of products and services associated with numerous local businesses. Such a database can be used by the on-line provider and/or link provider, acting on behalf of its local business customers, to unite the marketing objectives of larger, nationwide companies with local businesses.

In the course of operation, a database of products and services offered by local businesses is dynamically developed by the on-line provider. At the broadest level, the database associates each local business with a set of general services and products. For example, to list a local business within the aforementioned directory, a link provider may gather certain information from the local business, including the business' name and set of offered products and services. While doing so, the local business may categorize itself as a hair salon. Because it provides the back-end support to the local business and link provider, the on-line provider receives that categorization and is able to associate that category, hair salon, with the business name in a database format. Consequently, over time, the on-line provider database will be capable of properly categorizing and characterization a large number of local businesses.

In a preferred embodiment, the on-line provider's database is dynamically developed with greater detail of the local business' actual product and service offerings. More specifically, the present invention enables a local business to grow its Internet presence incrementally by adding integration interfaces to a standard Internet management application and using those integration interfaces to automatically extract data from proprietary applications and conduct commerce over the Internet. As previously discussed, the application may be resident on a local business' client device or hosted in a server by the on-line provider. When used for conducting commerce, the movement and formatting of product data between the local business' proprietary applications and third parties is managed and maintained in a database hosted by the on-line provider. As a result, the database maintains a current copy of the local business' inventory, purchases, and pending orders.

Alternatively, the local business can manually input its products and/or services into an interface having a secure connection with the on-line provider's database. That database can not only store the information for future cooperative marketing use but also maintain a current inventory for the local business for active management by the local business.

Once the local business database is built, it may be used as a basis to conduct cooperative marketing. Cooperative marketing is a marketing approach whereby two companies with complimentary economic interests engage in a coordinated marketing campaign in order to more cost-effectively promote their interests. For example, a cooperative marketing program can include paying for 25% of ad campaigns if the local business advertises that it is carrying a particular product made by the supplier company. Such programs may also include offering free equipment, such as shelves or refrigerators, with the supplier's logo to local businesses provided they use that equipment to only offer the supplier company's products. Such programs may also include co-sponsoring local events, provided the supplier's products are prominently displayed or used along with the local business' logos, products, and/or services.

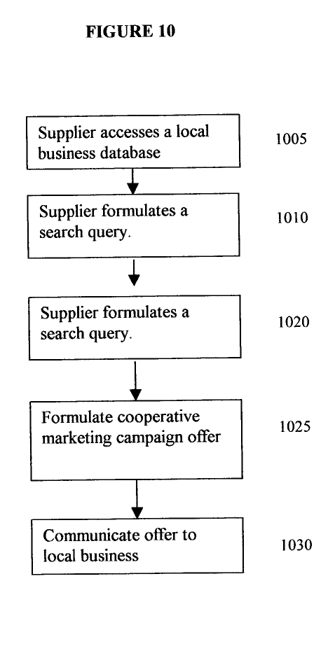

Referring to FIG. 10, a method for conducting cooperative marketing is shown. A supplier company accesses 1005 a database of local businesses in order to dynamically formulate a marketing program. The supplier company formulates 1010 a search query. That query could specify a particular geographical location, business type, or product/service type. In a typical use, a supplier company would specifically search 1010 for a local business already offering one or more of the supplier company's products. Once a particular set of companies has been identified 1020, the supplier company would then formulate 1025 a cooperative marketing campaign offer. That offer could then be communicated 1030 directly to the local business via an Internet accessible interface that receives text information and sends an email, fax, or phone message to the appropriate contact person at the local business.

A number of tools could be offered to supplier companies to assist them in finding appropriate cooperative marketing partners and crafting the right cooperative marketing program. For example, in addition to having the database list products carried by a local business, the database could also store information related to frequency of restocking, average lot sizes purchased, and how long the local business has been buying from the seller, such information gathered either directly from the local business or dynamically from the management of e-commerce data flowing between the local business and third party companies. The additional information will enable supplier companies to find their most loyal vendors and those vendors who are most successful at selling their products. Additionally, the database could be accompanied by a sponsorship opportunity database that, when associated with the geographical location of the identified local businesses, can highlight sponsorship opportunities in which both the local business and supplier company could be engaged. For example, upon identifying a particular set of local businesses that match a pre-designated set of criteria, the supplier company can then take the geographical locations of such local businesses, input the locations into the sponsorship opportunity database, and identify a set of proximate sponsorship opportunities that, together with the local business, it could sponsor.

The on-line provider's database can also be used to disseminate a local business' actual product and service offerings to a set of users. Operationally, a user may search for and identify a particular business name at a link provider's website. In a preferred embodiment, that business has a link that, when clicked, provides a list of all products currently in stock at the store. That list is generated by accessing the on-line provider's database of inventory information.

Alternatively, the local business can manually input its products and/or services into an interface having a secure connection with the on-line provider's database. That database can not only store the information for future cooperative marketing use but also maintain a current inventory for the local business for active management by the local business.

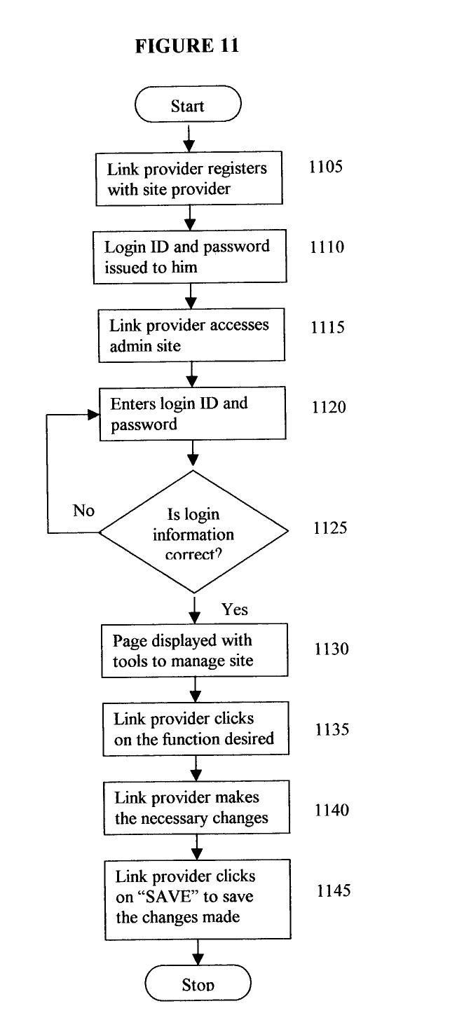

According to another embodiment of the present invention, the on-line provider provides the link provider with means to create its own Internet presence, and presents it with a set of tools to manage its web site on its own. The basic site for the link provider is created and hosted by the on-line provider. But going to the on-line provider for every small change in the site, would have made the process very tedious and unmanageable. Hence the link provider is provided with a set of tools to efficiently manage his own web site as and when required. Referring to FIG. 11, a process flow diagram of the same is shown. In one process, the link provider registers 1105 with the on-line provider or the site provider. Registration may be done either through the Internet, or by directly visiting the on-line provider. A login ID and password is issued 1110 to the link provider at the time of registration. This user ID and password is generated randomly by a software application and is stored in a database along with the link provider's other information. The link provider can now access his website using this login information. The link provider opens 1115 the administrative page, and enters 1120 his login ID and password. The login information is checked 1125 by matching it with the entries in the database. If the details match, the link provider is authorized to modify/add/delete the contents on his site, and a page is displayed 1130, which contains links to a plethora of functionalities that the link provider can use to edit his site easily. These functionalities include but are not limited to the following:

Add a new user

List all users

Edit FAQ page

Configure wizard

Generate a polling window

Edit polling questions

Create a local news

Edit local news

Edit banner ads

Edit left column menu bar

Edit local restaurants

Edit classifieds

Add classifieds

Add local events

Edit local events

Edit About Us page

The link provider now clicks 1135 on the function he desires. A corresponding Active Server Page (ASP) is generated and displayed which has a template for editing the site content for the selected item. The link provider then makes 1140 the desired changes and modifications in his content, and clicks 1145 ‘Update’ or ‘Save’ to transmit the corresponding changes to the database, so that the changes are reflected automatically in the database, and the edited page is displayed the next time a user accesses the link provider's site.

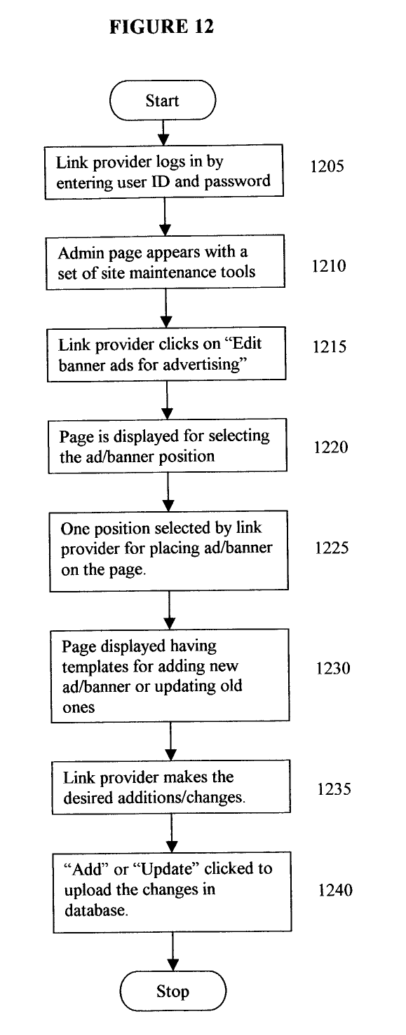

A specific functionality has been explained in FIG. 12 in the form of a process flow diagram. The link provider can use this functionality to add or modify a banner/ad on his site. The link provider logs in 1205 by entering his user ID and password. After the login information of the link provider is verified by matching it with the entries in the database, he is given authority to modify the site, and the administrative page having a set of tools for site maintenance gets displayed 1210. The link provider now clicks 1215 on the desired functionality i.e. “Edit banner ads for advertising”. Clicking this link displays 1220 a page for selecting the position of the banner/ad on the page. One position is selected 1225 by the link provider for placing the banner/ad on the page. An active server page is generated 1230 which has two different templates. One template is for adding a new banner/ad to the site. The link provider has to enter his customer's name, the URL of the ad/banner, and has to select an image for the banner/ad by means of the “Browse” button. After entering the required information 1235, the link provider clicks 1240 on “ADD” so that the addition is updated in the database. The change is simultaneously reflected on the website, and can be observed when the website is next viewed by a user. Similarly, the other template is for updating or editing a previously existing banner/ad. The link provider can change the customer's name, the ad's URL, or the image linked to it. After making the desired changes 1235, the link provider clicks 1240 on “UPDATE” so that the changes are updated in the database. The changes are simultaneously reflected on the website, and can be observed when the website is next viewed by a user.

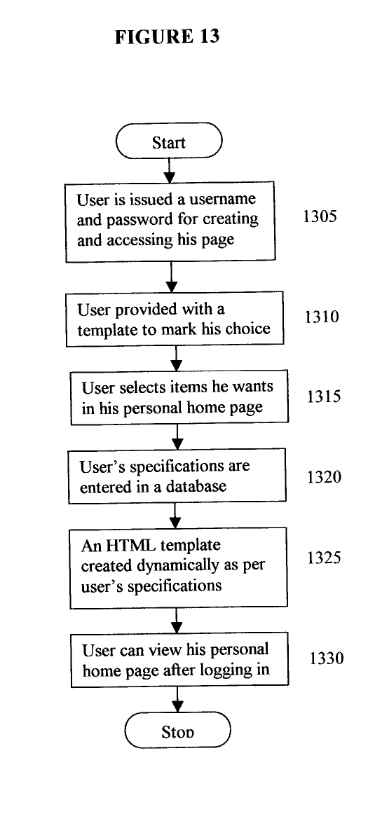

In another preferred embodiment, the link provider is provided with a set of tools by means of which it can permit the end users to customize their home page. Therefore a user can select what kind of news, weather reports etc, he wants to see on his personal home page. Referring to FIG. 13, a process flow diagram is shown. The basic process consists of the user being issued 1305 a username and password for creating and accessing his own personal home page. This is done by clicking on a link provided on the link provider's site, which may issue the user a random login ID and password, or may ask the user to select one for himself. Once registered, the user is provided 1310 with a template/wizard to customize his home page. This may comprise of a web page display having a set of checkboxes for accepting the user's choice. The available options may include choice of news items (business news, political news, sports news, etc), choice of miscellaneous items (classifieds, directories, community pages, entertainment, etc), choice of page look and layout (color combination, fonts, font size, etc). The user may also have the option of placing the news items according to his priority on the web page. The user selects 1315 the items that he wishes to include in his personal home page and may adjust the display if he wishes to. User's specifications are then transmitted 1320 to a database, and an HTML template gets dynamically generated 1325 as per the user's specifications. The user can now view 1330 his personal customized home page after logging in the portal.

While the invention has been illustrated and described by means of specific embodiments, it is to be understood that numerous changes and modifications may be made therein without departing from the spirit and scope of the invention as defined in the appended claims and equivalents thereof.

What is claimed is:

1. A method for providing users with information, comprising the steps of:
providing a link provider with a plurality of tools wherein said link provider has a network-accessible website having at least one feature and said tools enable the link provider to manage the at least one feature.
accepting content from the link provider wherein said content represents information about businesses within a geographically defined area that is proximate to said link provider;
storing the content in a database; and
allowing a user who accesses the website of said link provider to retrieve the content from the database.

2. The method of claim 1 wherein the retrieval step occurs by said user accessing the website through a wireless device, indicating a physical position through a GPS system, and receiving a list of businesses proximate to said position.

3. The method of claim 1 wherein the link provider includes at least one of a television station, a radio station, a magazine, a newspaper, a club, an organization, an association, a governmental agency or other business.

4. The method of claim 1 wherein the tools enable the link provider to perform at least one of a plurality of actions, including add a new user, list all users, edit a page, generate a polling window, edit polling questions, create local news, edit local news, edit banner ads, edit left column menu bar, edit local restaurants, edit classifieds, add classifieds, add local events, and edit local events.

5. A method for providing users with information, comprising the steps of:
providing a link provider with a plurality of tools wherein said link provider has a network-accessible website having at least one feature and said tools enable the link provider to manage the at least one feature, the at least one feature including an on-line reservation, a calendaring system, a coupon management system, or an inventory tracking system;
accepting content from the link provider wherein said content represents information about businesses within a geographically defined area that is proximate to said link provider;
storing the content in a database; and
allowing a user who accesses the website of said link provider to retrieve the content from the database.

6. A system for providing users with information wherein said system includes a plurality of servers in communication with a network, comprising at least one server in communication with a network and accessible to a link provider
wherein said link provider has a network-accessible website having at least one feature;
wherein said server hosts the network accessible website and has a plurality of tools, said tools enabling the link provider to manage the at least one feature;
wherein said server is capable of accepting content from the link provider, said content representing information about businesses within a geographically defined area that is proximate to said link provider; and
a storage device that is in communication with said server and stores the content in a database, said device being accessible by a user who accesses the website of said link provider to retrieve the content from the database.

7. The system of claim 6 wherein the user accesses content from the database by accessing the link provider website through a wireless device, indicating a physical position through a GPS system, and receiving a list of businesses proximate to said position.

8. The system of claim 6 wherein the link provider includes at least one of a television station, a radio station, a magazine, a newspaper, a club, an organization, an association, a governmental agency or other business.

9. The system of claim 6 wherein the tools enable the link provider to perform at least one of a plurality of actions, including add a new user, list all users, edit a page, generate a polling window, edit polling questions, create local news, edit local news, edit banner ads, edit left column menu bar, edit local restaurants, edit classifieds, add classifieds, add local events, and edit local events.

10. A method for providing a user with information about a business having e-commerce accessible applications wherein said information enables the user to electronically communicate with said e-commerce accessible applications, comprising the steps of:
providing the business having applications with a management application having a plurality of interfaces;
instructing said business on how to integrate said applications with at least one of said interfaces to form an e-commerce accessible application;
associating an integration protocol with said business; and
allowing the user to access information about the business, including said integration protocol, through a network accessible website, wherein said user is authorized to access said protocol.

11. The method of claim 10 wherein the network accessible website is associated with a link provider.

12. The method of claim 11 wherein the link provider includes at least one of a television station, a radio station, a magazine, a newspaper, a club, an organization, an association, a governmental agency or other business.

13. A directory system capable of providing a user with information about a business having e-commerce accessible applications wherein said information enables the user to electronically communicate with said e-commerce accessible applications, comprising:
a server in communication with a network wherein said server provides the business having applications with a management application having a plurality of interfaces; provides information instructing said business on how to integrate at least one of said applications with at least one of said interfaces to form an e-commerce accessible application; and associates an integration protocol with said business; and
a storage device capable of storing information about said business and of providing the user access to information about the business, including said integration protocol, through a network accessible website, wherein said user is authorized to access said protocol.

14. A method for conducting co-operative marketing between a seller and a business wherein the business has e-commerce accessible applications, comprising:
providing the business having applications with a management application having a plurality of interfaces;
instructing said business on how to integrate said applications with at least one of said interfaces to form an e-commerce accessible application;
associating an integration protocol with said business;
permitting a user to access information about the business, including said integration protocol, through a network accessible website, wherein said user is authorized to access said protocol;
managing the communication of data between said user and business wherein the data is exchanged using said protocol and includes information about the inventory of the business;
storing said inventory data; and
helping the seller identify businesses of interest to the seller by providing the seller access to said inventory data.

15. A method of informing a user of an offering wherein the offering is communicated through a web page and wherein said offering includes the name of an entity, comprising the steps of:
acquiring data representative of information describing a plurality of entities, said information including the name, location, and offerings of each of said entities;
compiling the data in a database structure;
in response to an action by the user, accessing a device being operated by said user to determine the geographical location of said user;
retrieving data representative of information describing a plurality of entities, wherein said entities are physically located proximate to the geographical location of said user; and
displaying said data in human readable form to the user.

16. The method of claim 15, wherein the step of acquiring data representative of information describing the plurality of entities includes providing the entities with a set of tools, said tools comprising applications to enable each of the said entities to create their own internet presence and assist them in translating their content onto the Internet.

17. The method of claim 15 wherein the database is maintained by an online site provider and stores the data of the plurality of entities, the data including name, address, phone number, and business type.

18. The method of claim 15 wherein the user operated device includes a wireless device capable of accessing the Internet that incorporates a global positioning system.

19. The method of claim 15, wherein an application is transmitted to the user operated device to enable the determination of the geographical location of the user.

20. A method of enabling the exchange of information across a network, comprising the steps of:
communicating in the form of a web page at least one protocol in association with a specific entity;
permitting a user to obtain additional details defining said at least one protocol;
receiving data from the user in a first format;
transforming said data into a second format in accordance with the at least one protocol; and
communicating the data in the second format to the entity.
